(19) United States
(12) Patent Application Publication
(10) Pub. No.: US 2006/0288231 A1
(43) Pub. Date: Dec. 21, 2006

(54) Method of managing data in network system and a network system using the same

(75) Inventors: Dae-youb Kim, Seoul (KR); Hwan-joon Kim, Seoul (KR); Maeng-hee Sung, Seoul (KR); Weon-il Jin, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/407,075

(22) Filed: Apr. 20, 2006

(30) Foreign Application Priority Data
Jun. 21, 2005 (KR) 10-2005-0053588

(51) Int. Cl. H04K 1/00

(52) U.S. Cl. 713/184

(57) ABSTRACT

Provided are a method of managing data in a network system and a network system using the method. The method includes substituting a master password for a predetermined function to generate a password; if a password for requesting an access to specific data is input, checking whether the input password matches with the generated password; and if the input password matches with the generated password, allowing the access to the specific data. Thus, in a case where a storage unit makes access levels of data into multilayered access levels to authenticate a password, the storage unit can store only a password to efficiently authenticate and manage an access to data.

### CROSS-REFERENCE TO RELATED APPLICATIONS

This application claims priority from Korean Patent Application No. 10-2005-0053588 filed Jun. 21, 2005, in the Korean Intellectual Property Office, the disclosure of which is incorporated herein by reference.

### BACKGROUND OF THE INVENTION

1. Field of the Invention

Apparatuses and methods consistent with the present invention relate to managing data in a network system, and more particularly, to a method of managing data in a network system using a password generated by a one-way hash function.

2. Description of the Related Art

A network system to which the present invention pertains includes at least one storage unit and at least one reader. Here, the storage unit is a storage device such as a smart card, radio frequency identification (RFID) tag, or the like.

The smart card can be highly secured and stabilized, and have a large storage capacity and an inner memory that may be divided and thus applied in various services of various fields. Applications of such smart cards can be classified into financing/settlement, information communications, mobile communications, medical welfare, access control, self-inspection, fare collecting, city complex cards, or the like. Also, fields in which the smart cards will be used are greatly expanding.

The RFID tag generally indicates a thin plane-type tag attached to an object in a non-contact way through a wireless signal. The RFID tag can be used in various fields including physical distribution, traffic, security, safety, and the like. Examples of application services of the RFID tag include robbery prevention of shopping centers, security systems such speaking medicines for blind persons, tamper-resistant devices, animal tracking devices, automobile security systems, devices permitting entrance and access of individuals, auto fare collecting systems, production management, conveyance container tracking systems, and the like. Also, the reader accesses the above-described storage unit to read information from the storage unit.

Here, the storage unit must control accesses to and uses of information thereof. A “one-password” authenticating method used in a smart card may be taken as an example of such an authenticating technique. However, in such an authenticating method, authentication is achieved one time through one password in order to access all kinds of stored data.

The above-described storage unit must set access levels of the stored data according to characteristics of the stored data to manage the stored data. In other words, the storage unit should restrict a reader allowed to access specific data to accessing that part of the stored data. In a case where a “multi-password” authenticating method is used due to the above requirement, several passwords must be stored and managed due to multilayered access levels.

### SUMMARY OF THE INVENTION

An aspect of the present invention provides a method of managing data in a network system using a password generated by a one-way hash function.

According to an aspect of the present invention, there is provided a method of managing data in a network system, including: substituting a master password for a predetermined function to generate a password; if a password for requesting an access to specific data is input, checking whether the input password matches with the generated password; and if the input password matches with the generated password, allowing the access to the specific data.

The predetermined function may be a one-way hash function.

The one-way hash function may be two independent one-way hash functions.

The method may further include substituting the generated password for the predetermined function to additionally generate a password used for checking whether a password input from an external source matches with the password.

The method may further include substituting the generated password for one of the two one-way hash functions to additionally generate a password used for checking whether a password input from an external source matches with the password.

The method may further include setting access levels according to data of which an access is determined to an allowance or a disallowance.

The method may further include determining data allowed to be accessed through the input password matching the generated password.

Data set to a lower level may be allowed to be accessed through a password corresponding to data set to an upper level through the setting of the access levels according to the data.

The generating of the password may be repeatedly performed.

If the input password does not match the generated password, the method may further include disallowing the access to the specific data.

According to another aspect of the present invention, there is provided a network system including: a storage unit substituting a master password for a predetermined function to generate a password, if a password for requesting an access to specific data is input, checking whether the input password matches with the generated password, and if the input password matches with the generated password, allowing the access to the specific data corresponding to the password; and a reader requesting an access to the specific data stored in the storage unit and inputting a password for receiving an allowance of the access to the specific data.

The predetermined function may be a one-way hash function.

The one-way hash function may be two independent one-way hash functions.

The storage unit may substitute the generated password for the predetermined function to additionally generate a password used for checking whether a password input from an external source matches with the password.

The storage unit may substitute the generated password for one of the two one-way hash functions to additionally generate a password used for checking whether a password input from an external source matches with the password.

The storage unit may set access levels according to data of which an access is determined to an allowance or a disallowance.

The storage unit may determine data allowed to be accessed through the input password matching the generated password.

Data set to a lower level may be allowed to be accessed through a password corresponding to data set to an upper level through the setting of the access levels according to the data.

The storage unit may repeatedly perform the generating of the password.

If the input password does not match the generated password, the storage unit may disallow the reader to access the specific data.

According to still another aspect of the present invention, there is provided a storage unit including: an access allowance determiner substituting a master password for a predetermined function to generate a password, if a password for requesting an access to specific data is input, checking whether the input password matches with the generated password, if the input password matches with the generated password, allowing the access to the specific data corresponding to the password; and a data storage unit storing the specific data.

The predetermined function may be a one-way hash function.

The one-way hash function may be two independent one-way hash functions.

The access allowance determiner may substitute the generated password for the predetermined function to additionally generate a password used for checking whether a password input from an external source matches with the password.

The access allowance determiner may substitute the generated password for one of the two one-way hash functions to additionally generate a password used for checking whether a password input from an external source matches with the password.

The access allowance determiner may set access levels according to data of which an access is determined to an allowance or a disallowance.

The access allowance determiner may determine data allowed to be accessed through the input password matching the generated password.

The access allowance determiner may allow an access to data set to a lower level through a password corresponding to data set to an upper level through the setting of the access levels according to the data.

The access allowance determiner additionally generates the password.

If the input password does not match the generated password, the access allowance determiner may disallow the reader to access the specific data.

According to yet another aspect of the present invention, there is provided a reader requesting an access to specific data of a storage unit substituting a master password for a predetermined function to generate a password, if a password for requesting an access to the specific data is input, checking whether the input password matches with the generated password, and if the input password matches with the generated password, allowing the access to the specific data.

### BRIEF DESCRIPTION OF THE DRAWINGS

The above aspects and features of the present invention will be more apparent by describing certain exemplary embodiments of the present invention with reference to the accompanying drawings, in which:

FIG. 1 is a view illustrating a method of managing data in a network system according to an exemplary embodiment of the present invention; and

FIG. 2 is a view illustrating a method of allotting a password to a reader in a network system according to an exemplary embodiment of the present invention.

### DETAILED DESCRIPTION OF THE EXEMPLARY EMBODIMENTS

Certain exemplary embodiments of the present invention will be described in greater detail with reference to the accompanying drawings.

In the following description, the same drawing reference numerals are used for the same elements throughout all of the drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

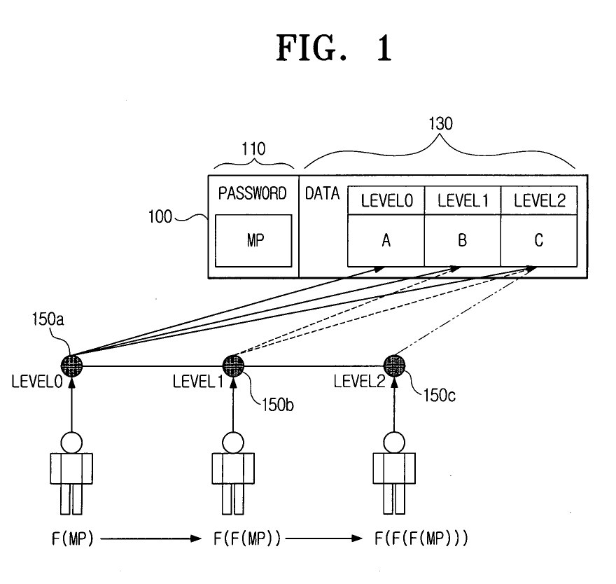

FIG. 1 is a view illustrating a method of managing a data in a network system according to an exemplary embodiment of the present invention. Referring to FIG. 1, the network system includes at least one storage unit 100 and a plurality of readers 150a, 150b, and 150c trying to access the at least one storage unit 100. Here, the storage unit 100 may be a smart card, an RFID tag, or the like, and includes an access allowance determiner 110 and a data storage unit 130.

The access allowance determiner 110 determines whether to allow accesses with respect to requests of the readers 150a, 150b, and 150c for access to data, and the data storage unit 130 stores several pieces of data, i.e., data A, B, and C.

Here, the data A is data corresponding to level “0” and allows only the access of the reader 150a corresponding to the level “0.”

Also, the data B is data corresponding to level “1” and allows only the access of the reader 150a and the reader 150b corresponding to the level “1.”

The data C is data corresponding to level “2” and allows only the access of the reader 150a corresponding to the level “0,” the reader 150b corresponding to the level “1,” and the reader 150c corresponding to the level

The data storage unit 130 of the storage unit 100 stores the data A, B, and C together with the levels “0,” “1,” and “2” for controlling accesses to the data A, B, and C. The data storage unit 130 may be allotted an access control index (ACI) and then store the data A, B, and C along with the ACI. The ACI may be position information as to a reader allowed to access corresponding data or the like.

Here, the reader 150a corresponding to the level “0” is data A, the reader 150b corresponding to the level “1” is data B, and the reader 150c corresponding to the level “2” is data C.

The data A, B, and C respectively have passwords a, b, and c. Thus, in a case where the readers 150a, 150b and 150c try to access the data stored in the data storage unit 130, the readers 150a, 150b and 150c respectively transmit the passwords a, b, and c together with data request signals to the storage unit 100.

Here, if the password a is input, an access to the data A, B, and C may be allowed. If the password b is input, an access to the data B and C may be allowed. If the password c is input, an access to the data C may be allowed.

In other words, the readers 150a, 150b, and 150c have restricted authorities (also referred to as “levels”) to access the data stored in the data storage unit 130 of the storage unit 100 and may be allotted passwords corresponding to corresponding levels from a password manager. In the present invention, the readers 150a, 150b, and 150c may be allotted the corresponding passwords from the storage unit 100.

The access allowance determiner 110 of the storage unit 100 stores a master password (MP) that is a single password, but not the passwords a, b, and c. Here, the MP may be generated by and stored in the access allowance determiner 110 of the storage unit 100.

The stored MP must be protected from external direct accesses. In other words, the stored MP must be safely stored and/or managed in terms of hardware and software and must not be exposed to the outside.

In the present invention, such an MP is provided as an input value in a predetermined function. Here, if the predetermined function is “F(x),” the input value of the MP is “F(MP)” and becomes the password a for receiving an allowance of an access to the data A, B, and C, i.e., “F(MP)=a.”

If “F(MP)=a” is input to the predetermined function, a result value of “F(F(MP))” is obtained and becomes the password b for receiving an allowance of an access to the data B and C, i.e., “F(F(MP))=b.”

If the “F(F(MP))=b” is input to the predetermined function, a result value of “F(F(F(MP)))” is obtained and becomes the password c for receiving an allowance of an access to the data C, i.e., “F(F(F(MP)))=c”.

In the present invention, the predetermined function may be a one-way hash function. Here, the one-way hash function compresses an input value with an arbitrary length into an output value with a determined length and has the following characteristics. In the one-way hash function, it is impossible to obtain an input value of a given output value and another input value of a given input value for computing the same output value. Also, it is impossible to detect two different input values for computing the same output value in the one-way hash function.

The one-way hash function satisfying the above-described characteristics is one of the functions applied for perfection, authentication, and denying of data.

In other words, if the one-way hash function is “F(x),” the access allowance determiner 110 inputs the MP to a one-way hash composite function “FN+1(x)” to generate a password corresponding to a level N. As a result, a result value of “FN+1(MP)” is obtained and becomes the password corresponding to the level N.

In other words, a password corresponding to data of level “0” is “F1(MP),” a password corresponding to data of level “1” is “F2(MP),” and a password corresponding to data of level “2” is “F3(MP).” According to an exemplary embodiment of the present invention, a level of data may be further multi-layered. Even in this case, a password corresponding to a corresponding level is generated using the same method.

In the present invention, those of ordinary skill in the art may use the MP as the password corresponding to the data of level “0.” In this case, an MP is input to the one-way hash composite function “FN(x): to generate the password corresponding to the level N. As a result, a result value of “FN(MP)” is obtained and may be the password the corresponding to the level N.

According to an exemplary embodiment of the present invention, the input and output values of the one-way hash function may be passwords having fixed bit lengths.

In a case where the access allowance determiner 110 of the storage unit 100 receives data request signals from the readers 150a, 150b, and 150c, the access allowance determiner 110 may perform a process of generating passwords. In a case where the access allowance determiner 110 do not receive the data request signals from the readers 150a, 150b, and 150c, the access allowance determiner 110 may perform the process.

In other words, the readers 150a, 150b, and 150c transmit their allotted levels and passwords and information as to desired data to the storage unit 100.

When the storage unit 100 receive the passwords from the readers 150a, 150b, and 150c, the storage unit 100 checks whether the received passwords are equal to the passwords generated in the above-described process.

If passwords generated by the one-way hash function include a password matching a password input from an external source, an access to data corresponding to the matching password is allowed. If the passwords generated by the one-way hash function include the password matching with the password input from the external source, the access to the data corresponding to the matching password is not allowed.

For example, if the password input from the external source is b, the access allowance determiner 110 of the storage unit 100 generates the passwords a, b, and c corresponding to respective levels of data using the MP thereof, and the one-way hash function checks whether a password matching with the password b exists. If the access allowance determiner 110 of the storage unit 100 determines that the password b is the password matching the input password, the access allowance determiner 110 allows an access to the data B and C corresponding to the password b.

According to another exemplary embodiment of the present invention, the access allowance determiner 110 of the storage unit 100 may check levels transmitted from the readers 150a, 150b, and 150c and selectively generate passwords corresponding to the corresponding levels using the one-way hash function.

As a result, the access allowance determiner 110 checks whether passwords input from the readers 150a, 150b, and 150c match with the selectively generated passwords. If the passwords input from the readers 150a, 150b, and 150c match with the passwords selectively generated by the one-way hash function, the access allowance determiner 110 allows accesses to data corresponding to the matching passwords.

If the passwords input from the readers 150a, 150b, and 150c do not match with the passwords selectively generated by the one-way hash function, the access allowance determiner 110 does not allow the accesses to the data corresponding to the matching passwords.

In the present invention, passwords generated by a single one-way hash function may be used as described above. However, passwords generated by a plurality of one-way hash functions may be used.

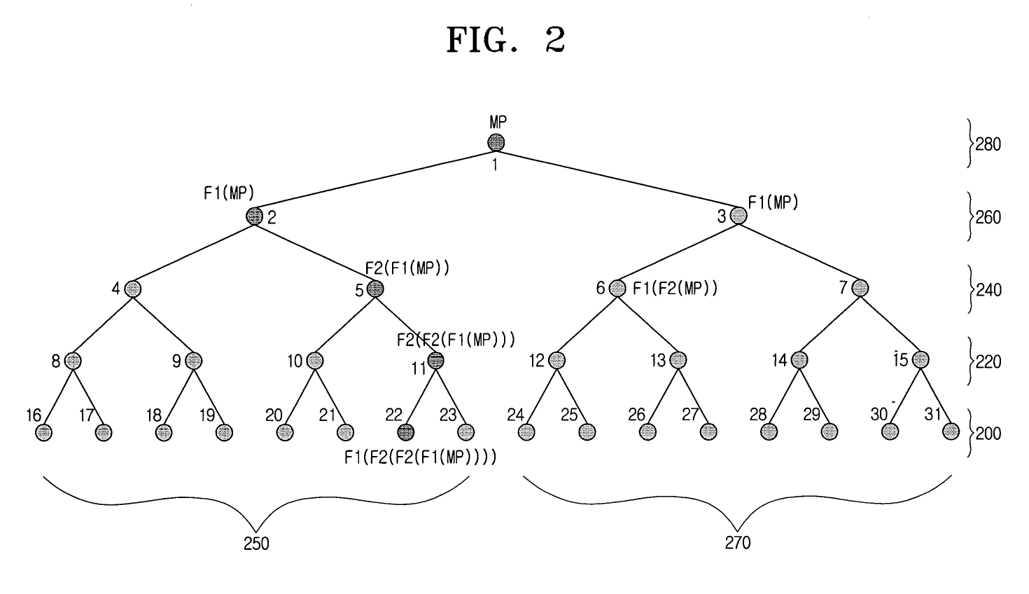

FIG. 2 is a view illustrating a method of allotting passwords to readers in a network system according to an exemplary embodiment of the present invention.

In a case where the present invention is applied to a physical distribution system, readers on a first layer 200 may be consumers' readers, readers on a second layer 220 may be retailers' readers, readers on a third layer 240 may be wholesalers' readers, and readers on a fourth layer 260 may be physical distribution centers' readers. Readers on a fifth layer 280 may be manufacturers' readers.

However, a password manager may set possibilities of accesses differently for specific data, depending on positions of readers on the same layer on a tree shown in FIG. 2.

For example, in a case where readers positioned on a left side 250 of the tree correspond to physical distribution systems in Seoul and readers position on a right side 270 correspond to physical distribution systems in Busan, the password manager may allow the readers of the physical distribution systems in Seoul not to access specific data to which the readers of the physical distribution systems in Busan can access.

In this case, the password manager may differently set a one-way hash function on the left and right sides 250 and 270 of the tree to allot different passwords to readers on the same layer, depending on positions of the readers on the tree.

Also, the password manager may differently set the one-way hash function on left and right sides of a partial tree constituting a part of the tree.

In other words, if the one-way hash function on the left sides of the entire tree and the partial tree is “F1(x)” and the one-way hash function on the right sides of the entire tree and the partial tree is “F2(x),” a password allotted to the reader 2 on the fourth layer 260 may be “F1(M),” and a password allotted to the reader 3 on the fourth layer 260 may be “F2(MP).”

As a result, although the readers 2 and 3 are positioned on the fourth layer 260, the readers 2 and 3 are allotted different passwords.

In addition, a password allotted to the reader 4 on the third layer 240 may be “F1(F1(MP)),” a password allotted to the reader 5 on the third layer 240 may be “F2(F1(MP)),” and a password allotted to the reader on the third layer 240 may be “F1(F2(MP)).”

As a result, although the readers 4, 5, and 6 are positioned on the third layer 240, the readers 4, 5, and 6 are allotted different passwords.

Also, a password allotted to the reader 11 on the second layer 220 may be “F2(F2(F1(MP)))” and different from passwords allotted to different readers on the second layer 220.

A password allotted to the reader 22 on the first layer 200 may be “F1(F2(F2(F1(MP))))” and different from passwords allotted to different readers on the first layer 200.

In the present invention, readers on the respective layers may be allotted passwords together with their position information using the above-described password allotting method.

Here, the position information indicates positions of the corresponding readers on the tree shown in FIG. 2, and a format of the position information may vary.

According to a first method, the position information may indicate a relative position from a single reader on the fifth layer 280. For example, if the left side “0” and the right side is “1,” position information of the reader 11 on the second layer 220 from the single reader of the fifth layer 280 is “011.”

This includes information indicating that the reader 11 is positioned on the left side on the fourth layer 260, on the right side on the third layer 240, and the right side on the second layer 220. The position information is 3 bits and includes information indicating that the reader 11 is positioned on the second layer 220 that is the third layer down from the single layer on the fifth layer 280.

According to a second method, the position information may be represented using position information of a layer to which the reader 11 belongs to and left and/or right position information. In other words, the reader 11 may select 4 bits, i.e., “1110,” as a format of layer position information indicating that a layer to which the reader 11 belongs to is the third layer down from the single reader on the fifth layer 280. If a specific reader is positioned at the fourth layer down, position information may be “1111.”

Also, the reader 11 may express “0110” as left and/or right position thereof. This includes information indicating that the reader 11 is positioned on the left side of the fourth layer 260 that is the first layer down from the single reader on the fifth layer, on the right side of the third layer 240 that is the second layer down from the single layer, and on the right side of the second layer 220 that is the third layer down from the single layer.

According to the second method, a bit corresponding to a digit “0” of bits of layer position information of bits of the left and/or right position information does not indicate the left and/or right position information. Thus, effective information of the position information of the reader 11 may be limited to a bit corresponding to a digit “1” of bits of the layer position information.

According to the second method, layer position information of the reader 22 may be “1111,” and left and/or right position information of the reader 22 may be “0110.” Also, an identification (ID) may be allotted to the corresponding reader using layer position information and left and/or right position information.

In other words, an ID of the reader 11 may be “[1110,0110],” and an ID of the reader 22 may be “[1111,0110].”

When a specific reader requests an access to data in the storage unit 100, the specific reader transmits a password allotted thereto and position information thereof together with a request signal.

The access allowance determiner 110 of the storage unit 100 checks a position of the specific reader on the tree from the position information of the specific reader and substitutes an MP for an input value in a one-way hash composite function depending on the corresponding position to generate a password for authenticating the specific reader.

As a result, if the transmitted password matches with the generated password, the access allowance determiner 110 allows an access to data corresponding to the corresponding password and the corresponding position information. If the transmitted password does not match the generated password, the access allowance determiner 110 does not allow the access to the data.

If the ACI stored along with the data in the data storage unit 130 of the storage unit 100 includes position information of a reader authorized to access the corresponding data, the ACI may be checked to determine data allowed to be accessed.

For example, the reader 22 transmits the ID “[1111,0110]” including a password allotted thereto and position information thereof together with a data request signal to request an access to the data in the storage unit 100.

The access allowance determiner 110 of the storage unit 100 checks a position of the reader 22 on the tree from the ID “[1111,0110]” and substitutes an MP for an input value in a one-way hash composite function depending on the corresponding position to generate a password “F1(F2(F2(F1(MP))))” for authenticating the reader 22.

As a result, if the input password matches with the password “F1(F2(F2(F1(MP)))),” the access allowance determiner 110 allows the reader 22 to access the corresponding data. If the input password matches with the password “F1(F2(F2(F1(MP)))),” the access allowance determiner 110 does not allow the reader 22 to access the corresponding data.

On the tree shown in FIG. 2, readers on an upper layer can compute passwords allotted to readers on a lower layer. However, it is difficult for the readers on the lower layer to estimate passwords allotted to the readers on the upper layer. Also, it is difficult for a reader on a layer to estimate passwords allotted to different readers on the same layer. This results from the use of different two one-way hash functions.

A method of computing passwords allotted to readers on a lower layer via readers on an upper layer will now be described.

In a case where the reader 5 computes a password allotted to the reader 22, the reader 5 may check position information there from an ID “[1100,0100]” thereof and position information of the reader 22 from the ID “[1111,0110]” of the reader 22.

The reader 5 checks through this whether the reader 22 is a child thereof. In other words, the reader 5 checks that the reader 22 is the child thereof from the fact that the ID “[1111,0110]” of the reader 22 includes the ID “[1100,0100]” thereof.

If the reader 5 checks that the reader 22 is the child thereof, the reader 5 may obtain a password allotted to the reader 22 from relative position information obtained from a subtraction the ID thereof from the ID of the reader 22. In other words, the reader 5 computes a function “F1(F2(x))” to which a password thereof must be input to obtain the password allotted to the reader 22 from the relative position information “[0011,0010]” and substitutes the password “F2(F1(MP))” thereof for the computed function “F1(F2(x))” to obtain the password “F 1 (F2(F2(F1(MP))))” of the reader 22

In other words, according to an exemplary embodiment of the present invention, parent readers on the tree shown in FIG. 2 may be allowed to access data to which child readers can access through their passwords. Even in a case where the parent readers are allowed to access the data using only passwords allotted to the child readers not their passwords, the parent readers may obtain the passwords allotted to the child readers using the above-described process so as to access desired data.

As described above, according to the present invention, in a case where a storage unit makes access levels of data into multilayered access levels to authenticate passwords, the storage unit can store only one password to efficiently authenticate and manage accesses to data.

The foregoing embodiments are merely exemplary and are not to be construed as limiting the present invention. The present teaching can be readily applied to other types of apparatuses. Also, the descriptions of the exemplary embodiments of the present invention are intended to be illustrative, and not to limit the scope of the claims, and many alternatives, modifications, and variations will be apparent to those skilled in the art.

What is claimed is:

1. A method of managing data in a network system, comprising:
substituting a master password for a predetermined function to generate a password;
if an input password for requesting an access to specific data is input, checking whether the input password matches the generated password; and
if the input password matches the generated password, allowing the access to the specific data.

2. The method of claim 1, wherein the predetermined function is a one-way hash function.

3. The method of claim 2, wherein the one-way hash function is two independent one-way hash functions.

4. The method of claim 1, further comprising substituting the generated password for the predetermined function to generate an additionally generated password used for checking whether an externally input password input from an external source matches the additionally generated password.

5. The method of claim 3, further comprising substituting the generated password for one of the two independent one-way hash functions to generate an additionally generated password used for checking whether an externally input password input from an external source matches the additionally generated password.

6. The method of claim 1, further comprising setting access levels according to data of which the access is determined to be an allowance or a disallowance.

7. The method of claim 1, further comprising determining data allowed to be accessed through the input password matching the generated password.

8. The method of claim 6, wherein data set to a lower level is allowed to be accessed through a password corresponding to data set to an upper level through the setting of the access levels according to the data.

9. The method of claim 5, wherein the generating of the password is repeatedly performed.

10. The method of claim 1, further comprising, if the input password does not match the generated password, disallowing the access to the specific data.

11. A network system comprising:
a storage unit substituting a master password for a predetermined function to generate a generated password, if an input password is input requesting access to specific data, checking whether the input password matches the generated password, and if the input password matches the generated password, allowing the access to the specific data; and
a reader requesting the access to the specific data stored in the storage unit and inputting a password for receiving an allowance of the access to the specific data.

12. The network system of claim 11, wherein the predetermined function is a one-way hash function.

13. The network system of claim 12, wherein the one-way hash function is two independent one-way hash functions.

14. The network system of claim 11, wherein the storage unit substitutes the generated password for the predetermined function to additionally generate an additionally generated password used for checking whether an externally input password input from an external source matches the additionally generated password.

15. The network system of claim 13, wherein the storage unit substitutes the generated password for one of the two one-way hash functions to additionally generate an additionally password used for checking whether an externally input password input from an external source matches the additionally generated password.

16. The network system of claim 11, wherein the storage unit sets access levels according to data of which the access is determined to be the allowance.

17. The network system of claim 11, wherein the storage unit determines data allowed to be accessed through the input password matching the generated password.

18. The network system of claim 16, wherein data set to a lower level is allowed to be accessed through a password corresponding to data set to an upper level through the setting of the access levels according to the data.

19. The network system of claim 15, wherein the storage unit repeatedly performs the generating of the additionally generated password.

20. The network system of claim 11, wherein if the input password does not match the generated password, the storage unit disallows the reader to access the specific data.

21. A storage unit comprising:
an access allowance determiner substituting a master password for a predetermined function to generate a password, if a password for requesting an access to specific data is input, checking whether the input password matches the generated password, if the input password matches the generated password, allowing the access to the specific data; and
a data storage unit storing the specific data.

22. The storage unit of claim 21, wherein the predetermined function is a one-way hash function.

23. The storage unit of claim 22, wherein the one-way hash function is two independent one-way hash functions independent of each other.

24. The storage unit of claim 21, wherein the access allowance determiner substitutes the generated password for the predetermined function to additionally generate an additionally generated password used for checking whether an externally input password input from an external source matches the additionally generated password.

25. The storage unit of claim 23, wherein the access allowance determiner substitutes the generated password for one of the two one-way hash functions to additionally generate an additionally generated password used for checking whether an externally input password input from an external source matches the additionally generated password.

26. The storage unit of claim 21, wherein the access allowance determiner sets access levels according to data of which the access is determined to an allowance or a disallowance.

27. The storage unit of claim 21, wherein the access allowance determiner determines data allowed to be accessed through the input password matching the generated password.

28. The storage unit of claim 26, wherein the access allowance determiner allows the access to data set to a lower level through the input password corresponding to data set to an upper level through the setting of the access levels according to the data.

29. The storage unit of claim 25, wherein the access allowance determiner additionally generates the additionally generated password.

30. The storage unit of claim 21, wherein if the input password does not match the generated password, the access allowance determiner disallows the reader to access the specific data.

31. A reader requesting an access to specific data of a storage unit substituting a master password for a predetermined function to generate a password, if a password for requesting an access to the specific data is input, checking whether the input password matches with the generated password, and if the input password matches with the generated password, allowing the access to the specific data.
